(19) United States
(12) Patent Application Publication
(10) Pub. No.: US 2006/0177567 A1
(43) Pub. Date: Aug. 10, 2006

(54) Window that Generates Solar-powered Electricity via a Plurality of Noncontiguous Solar Cells

(76) Inventor: Tyson York Winarski, Tempe, AZ (US)

Correspondence Address: TYSON Y. WINARSKI, 428 EAST SUSAN LANE, TEMPE, AZ, 85281, US

(21) Appl. No.: 10/906,173

(22) Filed: Feb. 5, 2005

(51) Int. Cl. B05D 5/12

(52) U.S. Cl. 427/74

(57) ABSTRACT

A double-pane window that produces electricity via a plurality of small, noncontiguous solar cells thereby allowing continued enjoyment of a portion of the views afforded by the glass panes themselves.

### FIELD OF THE INVENTION

The present invention generally relates to the field of solar generated electricity.

### BACKGROUND OF THE INVENTION

The traditional uses of panels of solar cells have not realized their full potential because the electricity produced by these panels of solar cells is more expensive than that generated by the consumption of fossil fuels.

Glass panes are a very common exterior feature of high-rise office and apartment buildings. Sometimes these high-rise buildings are called skyscrapers. Glass panes afford views for the workers and occupants in the high-rise buildings. Additionally, glass panes permit sunlight to enter the building, to illuminate its interior.

Via a plurality of small, noncontiguous solar cells, meaning that there are gaps between them, this invention uses solar cells to produce solar generated electricity while generally allowing a portion of the views afforded by glass panes themselves. It is preferred that these small, noncontiguous solar cells are between the glass panes of sealed double-pane windows, so that the solar cells are protected from weathering, contamination, and cleaning. These electricity-producing double-pane windows could be used in any structure, such as a home or trailer, as well as a high-rise building. However, these electricity-producing double-pane windows are particularly advantageous to high-rise buildings where there is so much glass in use.

### SUMMARY OF THE INVENTION

The present invention is for a double-pane window that also serves as a power source as the double-pane window houses a plurality of solar cells. More specifically, this invention has gaps between the plurality of solar cells, so that people can look out of the window and sunlight can enter the building while electricity is still provided.

Further advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation are best understood through the following description of a preferred embodiment of the present invention when read in conjunction with the accompanying drawings.

FIG. 1 shows a front view of a pane of glass with a plurality of solar cells.

FIG. 2 shows a pane of glass with cavities having sidewalls formed by stamping.

FIG. 3 shows a pane of glass with cavities having sidewalls formed by an auxiliary pane of glass.

FIG. 4 shows a pane of glass with cavities having sidewalls each formed by auxiliary structures.

FIG. 5 shows a cross section of a solar cell.

FIG. 6 shows a double-pane window utilizing a plurality of solar cells.

FIG. 7 shows a triple-pane window utilizing a plurality of solar cells.

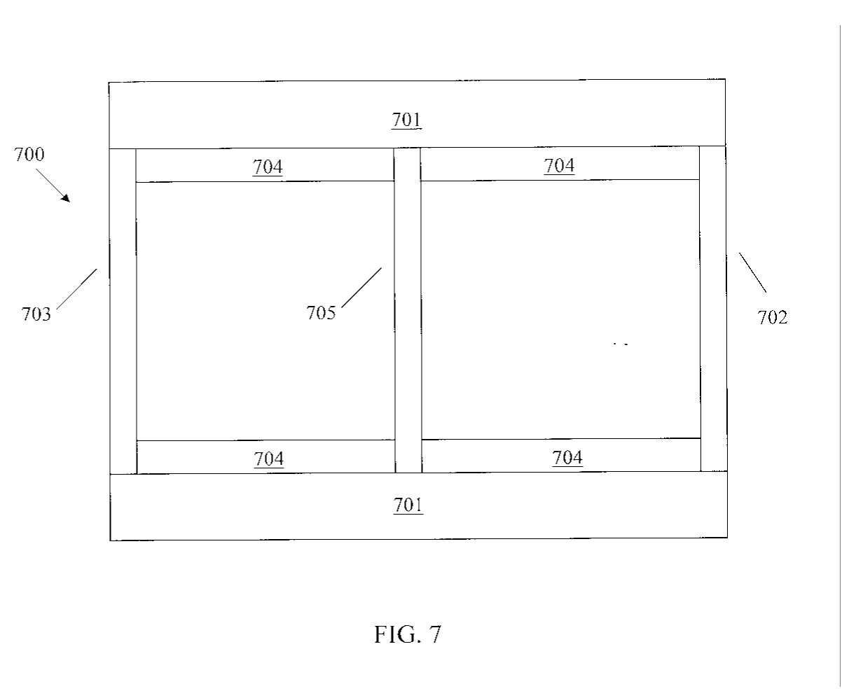

### DESCRIPTION OF PREFERRED EMBODIMENTS

While the invention has been shown and described with reference to a particular embodiment thereof, it will be understood to those skilled in the art, that various changes in form and details may be made therein without departing from the spirit and scope of the invention.

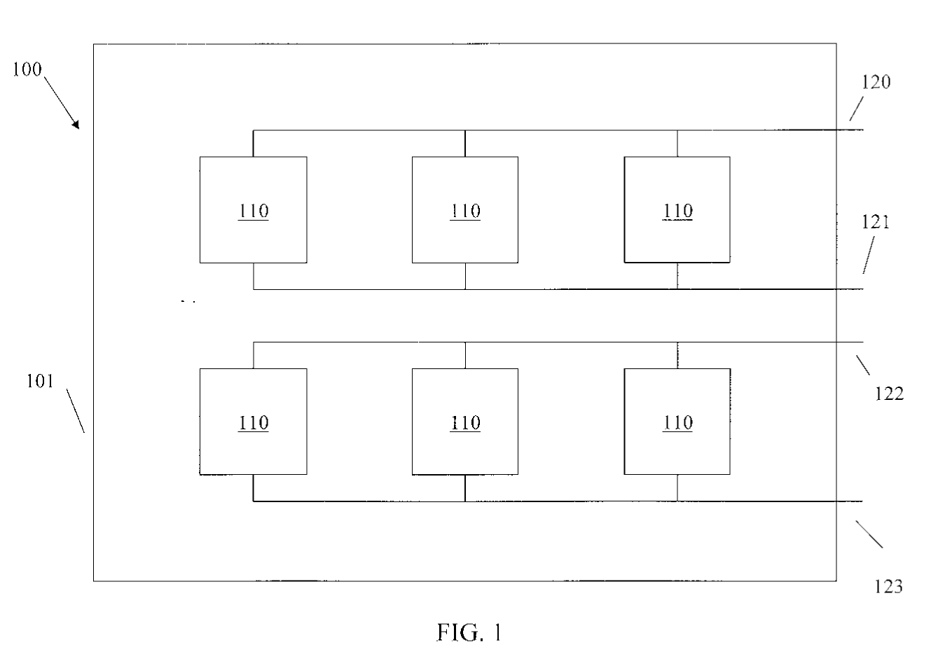

Referring to the Figures by characters of reference, FIG. 1 shows electricity producing window 100, comprising a front view of a pane of glass 101 which has a plurality of noncontiguous solar cells 110 and electrical conductors 120-123. FIG. 1 shows that the solar cells 110 are noncontiguous, so that sunlight can enter and people can view out of window 100. Solar cells 110 are shown as square in FIG. 1. However, solar cells 110 may be of any artistic shape, such as circular, hexagonal, octagonal, triangular, square, or an irregular polygon. Although solar cells 110 can be of any size, the approximate typical size of solar cells 110 is smaller than fifty millimeters and larger than ten millimeters. The effect of the plurality of noncontiguous solar cells 110 is that when viewed from a distance, window 100 has the appearance of being tinted, in that less light is admitted than an obstructed pane of glass but the viewer still can see through the glass.

Electrical conductors 120-123 are preferably oxide semiconductors such as indium oxide In₂O₃, tin oxide SnO₂, or indium tin oxide (ITO) which is a mixture of indium oxide and tin oxide. These oxide semiconductors in thin film form have the unique properties of good electrical conductivity and high optical transparency. Alternately, electrical conductors 120-123 are wires made of copper, or other conductive metals such as aluminum or gold. Electrical conductors 120 and 121 are of opposite polarity. Similarly, electrical conductors 122 and 123 are of opposite polarity.

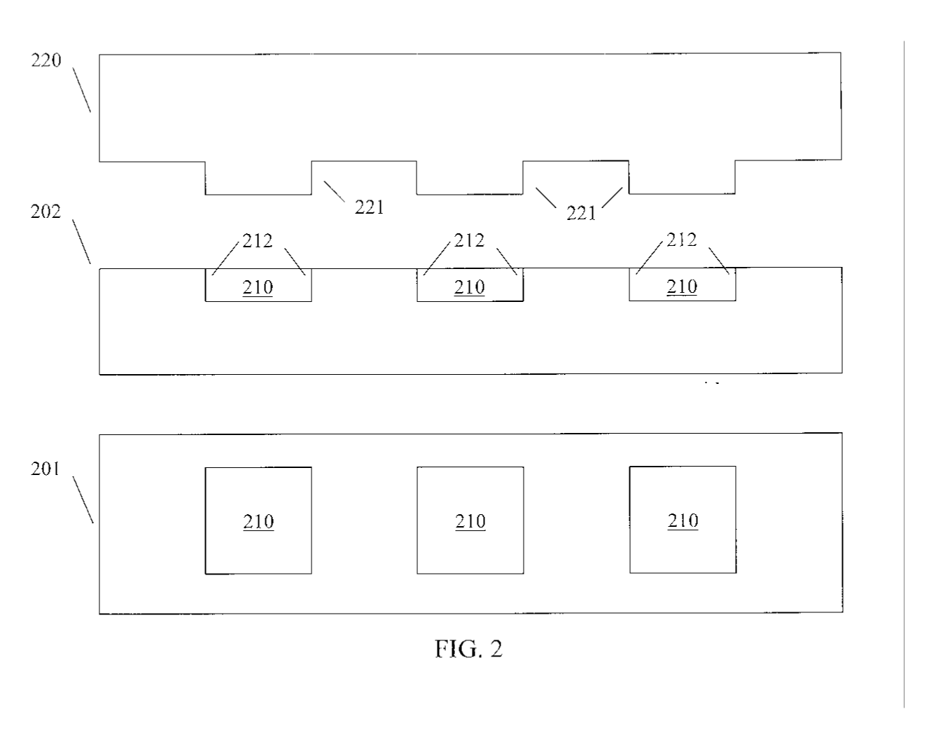

Solar cells 110 are typically thin-film solar cells, due to their low-cost due to low-cost processing, and the use of relatively low-cost materials. One example of solar cell 110 utilizes undoped amorphous silicon (a-SI) and hydrogenated amorphous silicon (n+a-Si). Another example of solar cell 110 utilizes AlGaAs (Aluminum Gallium Arsenide) and GaAs (Gallium Arsenide). FIGS. 2-4 show the employment of sidewalls to contain the chemical constituents of solar cells 110 during the fabrication of these solar cells.

FIG. 2 shows stamper 220 with indenters 221 which are pressed into hot glass 202 to form indentations 210 with sidewalls 212. Front view 201 of glass 202 shows an additional view of the formation of indentations 210 for the construction of solar cells 110.

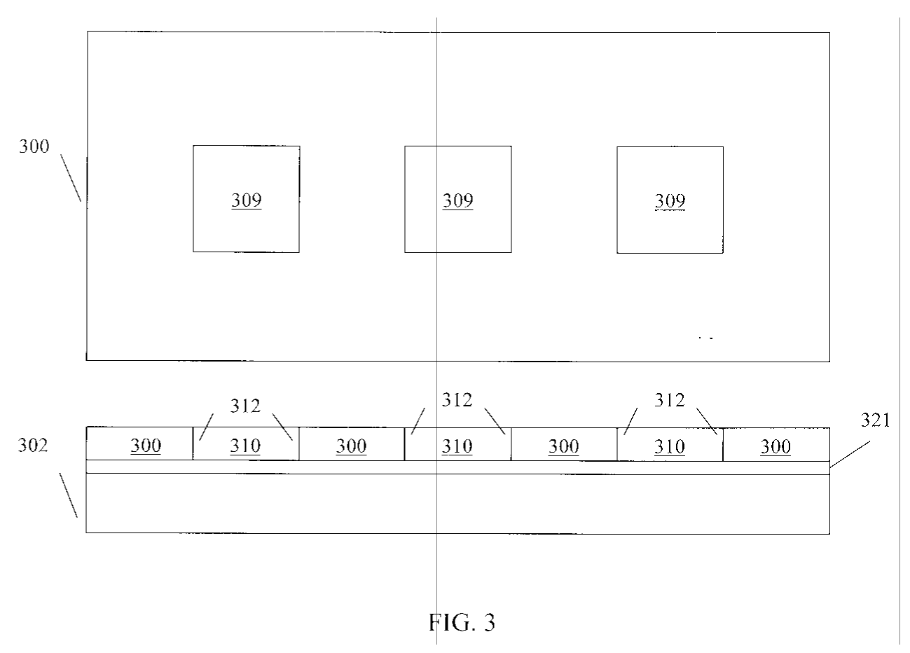

FIG. 3 shows a front view of auxiliary layer of glass 300 which has openings 309. Auxiliary layer of glass 300 is laid over glass 302 to form open cavities 310 with sidewalls 312, for the construction of solar cells 110. Conductor 321 may be sandwiched between auxiliary layer of glass 300 and glass 302. Electrical conductor 321 is preferably an oxide semiconductor such as indium oxide In₂O₃, tin oxide SnO₂, or indium tin oxide (ITO) which is a mixture of indium oxide and tin oxide. These oxide semiconductors in thin film form have the unique properties of good electrical conductivity and high optical transparency. Alternately, electrical conductor 321 is wire made of copper, or other conductive metal such as aluminum or gold.

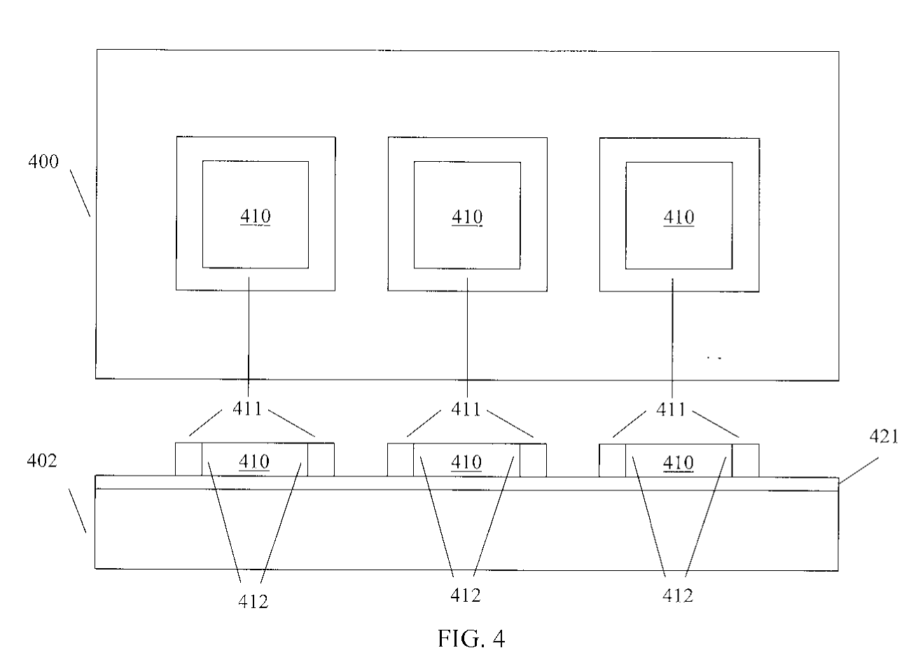

FIG. 4 shows front view 400 of glass 402 which has auxiliary walls 411. Auxiliary sidewalls 411 are laid over glass 402 to form cavities 410 with sidewalls 412, for the construction of solar cells 110. Conductor 421 may be sandwiched between auxiliary walls 411 and glass 402. Electrical conductor 421 is preferably an oxide semiconductor such as indium oxide In₂O₃, tin oxide SnO₂, or indium tin oxide (ITO) which is a mixture of indium oxide and tin oxide. These oxide semiconductors in thin film form have the unique properties of good electrical conductivity and high optical transparency. Alternately, electrical conductor 421 is wire made of copper, or other conductive metal such as aluminum or gold. Auxiliary walls 411 may be permanently attached to glass 402. However, auxiliary walls 411 may be only temporarily attached to glass 402 and once solar cells 110 are formed in cavities 410, auxiliary walls 411 are removed from glass 402.

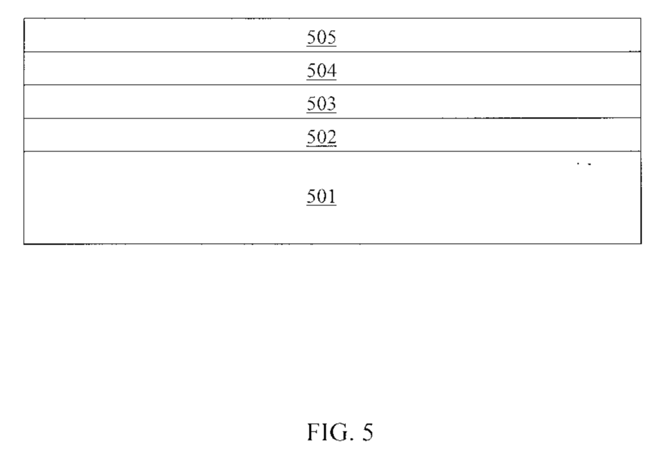

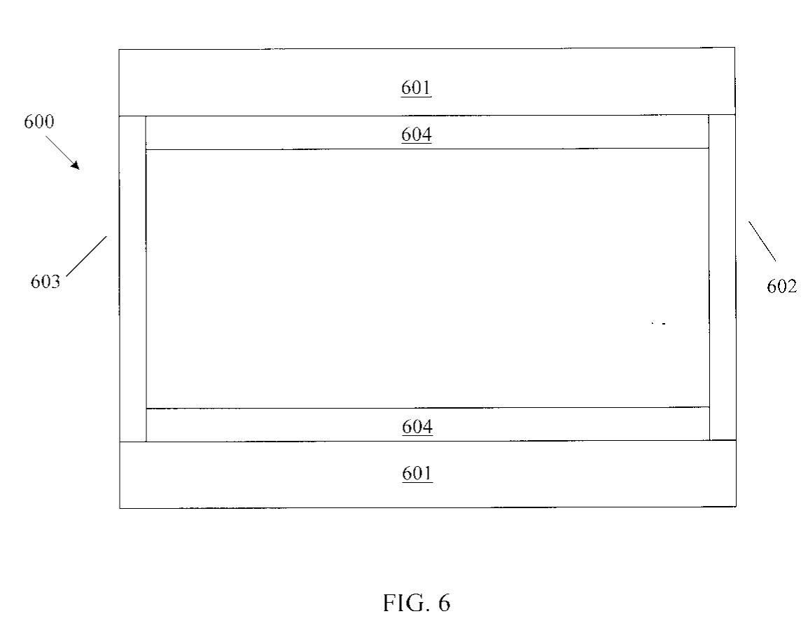

FIG. 5 shows a cross-section of solar cell 110. Adjacent to glass 501 is electrical conductor 502. Electrical conductor 502 is preferably an oxide semiconductor such as indium oxide In₂O₃, tin oxide SnO₂, or indium tin oxide (ITO) which is a mixture of indium oxide and tin oxide. These oxide semiconductors in thin film form have the unique properties of good electrical conductivity and high optical transparency. Alternately, electrical conductor 502 is wire made of copper, or other conductive metal such as aluminum or gold. Layers 503 and 504 are the components of solar cell 110, such amorphous silicon (a-SI) and hydrogenated amorphous silicon (n+a-Si). It is preferred that solar cell 110 is on the outer pane of glass of a double-pane window, FIG. 6, which would mean that layer 503 is the amorphous silicon (a-SI) and layer 504 hydrogenated amorphous silicon (n+a-Si). Electrical conductor 505 is preferably an oxide semiconductor such as indium oxide In₂O₃, tin oxide SnO₂, or indium tin oxide (ITO) which is a mixture of indium oxide and tin oxide. These oxide semiconductors in thin film form have the unique properties of good electrical conductivity and high optical transparency. Alternately, electrical conductor 505 is wire made of copper, or other conductive metal such as aluminum or gold.

Double-pane window 600 is preferably sealed against contaminants such as dust, dirt, and debris by seals 601 which run along the outer perimeter of double-pane window 600. In conjunction with seal 601, spacer 604 also runs along the outer perimeter of double-pane window 600 to keep exterior pane 602 and interior pane 603 uniformly spaced. Seal 601 and spacer 604 preferably have the same thermal coefficient of expansion so that during diurnal and seasonal temperature changes, the seal is maintained. A typical material for seal 601 and spacer 604 is aluminum or an aluminum alloy. A thin elastomeric coating on seal 601 and spacer 604, such as polytetrafluoroethylene, may be used to augment the sealing. Glass pane 100 is preferably used as exterior pane 602. However, glass pane 100 could be interior pane 603.

Triple-pane window 700 is preferably sealed against contaminants such as dust, dirt, and debris by seals 701 which run along the outer perimeter of triple-pane window 700. In conjunction with seal 701, spacers 704 also run along the outer perimeter of triple-pane window 700 to keep exterior pane 702, middle pane 705, and interior pane 703 uniformly spaced. Seal 701 and spacers 704 preferably have the same thermal coefficient of expansion so that during diurnal and seasonal temperature changes, the seal is maintained. A typical material for seal 701 and spacers 704 is aluminum or an aluminum alloy. A thin elastomeric coating on seal 701 and spacer 704, such as polytetrafluoroethylene, may be used to augment the sealing. Glass pane 100 is preferably used as exterior pane 702. However, glass pane 100 could be interior pane 703 or middle pane 705.

Groups of solar cells 110 are connected in series to increase DC (direct current) voltage and these groups may be connected in parallel to increase DC current. A DC-to-AC (alternating current) converter (not shown) may be used to convert the DC current and voltage from solar cells into AC current and voltage which would then be fed into the AC power grid of the building. The AC current and voltage output of DC-to-AC would preferably vary at a frequency of sixty Hertz (sixty times a second) in the United States and preferably vary at a frequency of fifty Hertz in Europe. If the AC current and voltage output of DC-to-AC converter is being superimposed with purchased AC power from a utility, the phase of the AC current and voltage from DC-to-AC converter will have to match the phase of the AC current and voltage from the utility. In this manner, the solar generated DC electricity from window 100 is converted to usable AC electricity while window 100 still provides interior illumination and a view of the outside world.

While the invention has been shown and described with reference to a particular embodiment thereof, it will be understood to those skilled in the art, that various changes in form and details may be made therein without departing from the spirit and scope of the invention. For example, solar cells 110 may simply be separately manufactured and merely adhered in place on window 100 using a conventional adhesive such as epoxy. Additionally, solar cells 110 may comprise thin-ribbons of solar cells which are in noncontiguous rows or columns separated by open glass for viewing and admitting light into a building.

What is claimed is:

1. A method for forming a plurality of noncontiguous solar cells on a glass pane, comprising:
creating sidewalls in said glass pane;
layering a first conductor on said glass pane;
layering a solar cell within the confines of said sidewalls; and
layering a second conductor onto said solar cell.

2. The method of claim 1, wherein said first and second conductors are from the group of oxide semiconductors including indium oxide, tin oxide, and indium tin oxide.

3. The method of claim 1, wherein said first and second conductors are wires made from a metal.

4. The method of claim 1, further comprising creating said sidewalls by stamping.

5. The method of claim 1, further comprising creating said sidewalls by use of an auxiliary layer of glass.

6. The method of claim 1, further comprising creating said sidewalls by use of auxiliary walls.

7. A method for forming a plurality of noncontiguous solar cells on a glass pane, comprising:
layering a first conductor on said glass pane;
creating sidewalls on said glass pane;
layering a solar cell within the confines of said sidewalls; and
layering a second conductor on said solar cell.

8. The method of claim 7, wherein said first and second conductors are from the group of oxide semiconductors including indium oxide, tin oxide, and indium tin oxide.

9. The method of claim 7, wherein said first and second conductors are wires made of metal.

10. The method of claim 7, further comprising creating said sidewalls by use of an auxiliary layer of glass.

11. The method of claim 7, further comprising creating said sidewalls by use of auxiliary walls.
